(19) United States
(12) Patent Application Publication
(10) Pub. No.: US 2003/0037697 A1
(43) Pub. Date: Feb. 27, 2003

(54) Second step polishing by CMP

(76) Inventor: Jinru Bian, Newark, DE (US)

Correspondence Address: Rodel Holdings, Inc., Suite 1300, 1105 North Market Street, Wilmington, DE, 19899, US

(21) Appl. No.: 09/933,698

(22) Filed: Aug. 21, 2001

(51) Int. Cl. C09G 1/00; C09G 1/02; C09G 1/04

(52) U.S. Cl. 106/3; 51/307; 51/308; 51/309

(57) ABSTRACT

A polishing fluid for polishing a metal includes, submicron particles, water, and a nonoxidizing reagent for removal of the metal, the nonoxidizing reagent being a hard base anion species of a Lewis base having a chemical bonding affinity for the metal to deter formation of a passivation oxide on the metal, which hard base anion is present in a concentration that maximizes removal of the metal in the absence of the passivation oxide.

### FIELD OF THE INVENTION

The invention relates to chemical mechanical planarization, CMP, and, more particularly, to second step polishing by CMP to remove a barrier film from an underlying dielectric layer on a semiconductor wafer.

### BACKGROUND OF THE INVENTION

A semiconductor wafer has a wafer of silicon and a dielectric layer in which multiple trenches are arranged to form a pattern of circuit interconnects. A barrier film is applied over the underlying dielectric layer, followed by a metal layer applied over the barrier film. The metal layer is applied in sufficient thickness to fill the trenches with metal.

CMP, chemical mechanical planarization, refers to a process of polishing with a polishing brush and a polishing fluid. First step polishing by CMP is performed to remove the metal layer from the underlying barrier film and from the underlying dielectric layer. The metal layer is removed, both by abrasion applied by the polishing pad, and by chemical reaction with the polishing fluid accompanied by dissolution of the products of chemical reaction. First step polishing removes the metal layer, while leaving a smooth planar polished surface on the wafer, and further leaving metal in the trenches to provide circuit interconnects that are substantially planar with the polished surface.

According to WO 0028 586, a known polishing fluid for first step polishing comprises, an aqueous solution having KNO₃ serving as a known oxidizing reagent when present in a polishing fluid of pH equal to or less than 2. A copper metal layer is removed by abrasion applied by the polishing pad, accompanied by oxidation of the copper in the polishing fluid. Further, copper is removed, first, by chemical reaction, i.e., oxidation of the metal layer by reaction with KNO₃. The oxides on the metal layer are removed by abrasion applied by the polishing pad, accompanied by dissolving in the polishing fluid. Further, the polishing pad abrades the metal layer to minimize redeposition of the dissolved oxides from the solution onto the surface of the material being polished. The copper is removed from an underlying barrier film, for example, of Ta or TaN. The barrier film is more resistant to abrasion than is the copper, such that the barrier film is a stop surface for stopping the first step polishing of copper. Further, oxidation of the surface of the barrier film by the polishing fluid will inhibit its removal during first step polishing.

Second step polishing by CMP is performed to remove a barrier film that remains on the semiconductor wafer, subsequent to completion of first step polishing. Second step polishing removes the barrier film from an underlying dielectric layer on a semiconductor wafer. Further, second step polishing provides a smooth, planar polished surface on the dielectric layer. Further, second step polishing avoids removing the metal in the trenches, which would contribute to dishing.

Dishing is a name for unwanted cavities in the circuit interconnects, which results from removing metal in trenches by the process of CMP. Dishing can result from, both first step polishing, and second step polishing. The circuit interconnects are required to have precise dimensions that determine the electrical impedance of signal transmission lines, as provided by the circuit interconnects. Dishing in excess of acceptable levels causes dimensional defects in the circuit interconnects, which contributes to attenuation of electrical signals transmitted by the circuit interconnects. Accordingly, to avoid dishing, the polishing fluid suitable for second step polishing is purposely without an oxidizing reagent of the metal in trenches, for example, copper metal. An unwanted oxidizing reagent of such metal in the polishing fluid would enhance removal of such metal by polishing, which would contribute to unwanted dishing. The polishing fluid for second step polishing is unlike the polishing fluid for first step polishing that comprises an oxidizing reagent of the metal for purposeful removal of a metal layer from an underlying barrier film.

Erosion is a name for unwanted lowering of the surface of the dielectric layer, which results from removing some of the dielectric layer by the process of CMP. Erosion that occurs adjacent to the metal in trenches causes dimensional defects in the circuit interconnects, which contributes to attenuation of electrical signals transmitted by the circuit interconnects. Accordingly, to minimize erosion, a polishing fluid for second step polishing is desired to remove the barrier film with a higher removal rate than the removal rate for the dielectric layer. Selectivity is expressed as a ratio of; the removal rate of the barrier film, to a removal rate of the dielectric layer. Thus, selectivity is a measure of the removal of the barrier film relative to the dielectric layer. A high selectivity is desired. Polishing with a polishing fluid that exhibits high selectivity, maximizes removal of the barrier film relative to the dielectric layer, which minimizes erosion.

U.S. Pat. No. 6,001,730 discloses polishing with a second CMP slurry consisting of, an amine compound, abrasive and water to obtain a selectivity of 550:340, or 1.62, pertaining to removal of a barrier film relative to a dielectric, and a selectivity of 550:330, or 1.67, pertaining to removal of a barrier film relative to copper metal.

### SUMMARY OF THE INVENTION

The invention provides a polishing fluid for removing a barrier film from a dielectric layer on a semiconductor wafer by polishing the wafer with the polishing fluid and a polishing pad.

Embodiments of the invention will now be described by way of example, with reference to the following detailed description.

### DETAILED DESCRIPTION

Experiments were conducted to test variations in the composition of a polishing fluid for second step polishing by CMP to remove a barrier film of TaN from an underlying dielectric layer of silica on a semiconductor wafer. Further, the same Experiments were conducted to remove copper metal from a semiconductor wafer, wherein, the copper metal simulated metal in trenches in a semiconductor wafer.

With reference to Table 1, experiments were performed by polishing a barrier film of TaN and a dielectric layer of silica, using a polishing pad and a polishing fluid of pH=9. The pH=9 is a nominal value. All values recorded in Table 1 are nominal values. All stated measurements of the constituents, as well as the pH measurement, are variable, respectively, about their stated nominal values. The polishing fluid is commercially available as 3285 Slurry, a commercial product of Rodel, Inc., an affiliated company of Rohm and Haas Company, Philadelphia, Pa., USA. The polishing fluid comprises, submicron particles of silica, water, benzotriazole, BTA, citric acid, ammonium chloride, a biocide, for example, Neolone™ M-50 biocide, available from Rohm and Haas Company, Philadelphia, Pa., USA, and a surfactant. Surfactants, for example, are disclosed by U.S. Pat. No. 6,117,775. Adjustments in the concentrations are made to enhance the properties of the polishing fluid. Adjusting the weight percent of silica adjusts the rate of abrasion and the amount of scratches produced by polishing. Adjusting the concentration of BTA adjusts the amount of which metals on the wafer are inhibited from oxidation. Adjusting the concentrations of citric acid and ammonium chloride adjusts the etch rate of metals. The biocide concentration is adjusted according to concentrations as prescribed by the supplier. Adjusting the concentration of a surfactant determines the amount of which the dielectric layer is inhibited from chemical reaction with the polishing fluid.

Table 1 describes a two factor, two level, Design Of Experiment, DOE, which records changes in removal rates resulting from interaction of two combined variables one to the other. Table 1 records observed changes in removal rates of a barrier film and changes in removal rates of a dielectric layer, due to varying the weight percent of a soluble salt dissolved in a polishing fluid of pH=9, and due to varying the weight per cent of abrasives in the polishing fluid. Further, changes in removal rates of copper metal were recorded.

TABLE 1

| | | | | | | Two- | | |
|---|---|---|---|---|---|---|---|---|
| | | | | | | Factor, | | |
| | | | TaN | Dielectric | | Two-Level | Cu | |
| Exp. | Abrasive | KNO3 | RR1 | RR2 | Selectivity | DOE | RR3 | Selectivity |
| Number | (%) | (%) | (A⁰/min.) | (A⁰/min.) | RR1/RR2 | Conclusion | (A⁰/min.) | RR1/RR3 |
| SPG- | High | Low | 1270 | 462 | 2.7 | Dielectric | 424 | 2.9 |
| 114 | 10.00 | 0.00 | | | | RR2 and | | |
| | | | | | | Selectivity | | |
| | | | | | | RR1/RR2 of | | |
| | | | | | | standard | | |
| | | | | | | fluid. | | |
| SPG- | High | High | 1881 | 648 | 2.9 | No good: | 273 | 6.9 |
| 115 | 10.00 | 4.00 | | | | Dielectric | | |
| | | | | | | RR2 high. | | |
| | | | | | | Selectivity | | |
| | | | | | | low. | | |
| SPG- | Low | Low | 35 | 23 | 1.5 | No good: | 221 | 0.16 |
| 116 | 1.00 | 0.00 | | | | TaN and | | |
| | | | | | | Dielectric | | |
| | | | | | | RR low. | | |
| | | | | | | Selectivity | | |
| | | | | | | low. | | |
| SPG- | Low | High | 1300 | 69 | 18.8 | Good: High | 270 | 4.8 |
| 117 | 1.00 | 4.00 | | | | TaN RR1. | | |
| | | | | | | Low | | |
| | | | | | | Dielectric | | |
| | | | | | | RR2. High | | |
| | | | | | | selectivity. | | |

With reference to Table 1, column I records Experiment Number SPG-114 that was performed by polishing a semiconductor wafer with a polishing pad, and with a polishing fluid of pH=9, and, further, of a known formulation used for second step polishing.

Further, Table 1 records in column 2, for Experiment Number SPG-114, that the polishing fluid was adjusted with a high level of Abrasive (10.00 per cent) and in column 3, a low level of KNO₃ (0.00 per cent). Column 4 records the observed removal rate, RR1, (1270 Angstroms per minute) that corresponds to removal of TaN from the wafer by polishing. Column 5 records the observed removal rate, RR2, (462 Angstroms per minute) that corresponds to removal of a dielectric layer of silica from the wafer by polishing. Column 6 records the Selectivity, RR1/RR2, as (2.7). The observed RR2 was a relatively high value, which caused Selectivity to be relatively low. Column 7 records the Two-factor two-level DOE Conclusion, based upon qualitative analysis of the observed RR1, RR2 and the Selectivity, RR1/RR2.

Table 1 further records Experiment SPG-115. Experiment SPG-115 indicates that when the concentration of Abrasive remained high, at (10.0%), and the concentration of KNO₃, was adjusted to a high, at (4.00%), then the observed RR2 was high, which caused Selectivity to be low.

Table 1 further records Experiment SPG-116. Experiment SPG-116 indicates that when the weight percent of Abrasive was adjusted to a low (1.00%) and the concentration of KNO₃ was adjusted to a low (0.00%), then both RR1 and RR2 were low, which caused Selectivity to be low. As expected, when the weight percent of Abrasive was reduced, from high to low, the removal rate of all materials from the wafer by polishing was reduced. Prior to the invention, a weight percent of Abrasive of about 1%, as disclosed by Table 1, polished the barrier film to remove the barrier film at an unacceptably low rate of removal, RR1=35 Angstroms per minute.

Table 1 indicates that an unacceptable, low rate of removal, RR1, of the barrier film occurs when polishing the barrier film with a polishing pad and a polishing fluid having a relatively low weight percent of Abrasive. Accordingly, prior to the invention, a polishing fluid suitable for removal of a barrier film from a semiconductor wafer required a high weight percent concentration of abrasives, i.e., about 7.5%. Lowering the weight percent of abrasives, together with an absence of KNO₃, or together with, a low level of KNO₃, resulted in a polishing fluid for which the removal rate of the barrier film was at an unacceptable low level, and a Selectivity RR1/RR2 at an unacceptable low level. Experiment SPG-116 indicates that a reduced weight percent of Abrasive, in the absence of KNO₃, or in the presence of a low concentration of KNO₃, results in an unacceptable, low removal rate, RR1, of the barrier film, and an unacceptable, low Selectivity, RR1/RR2, for removal of the barrier film relative to the Dielectric layer.

Table 1 further records Experiment SPG-117. Experiment SPG-117 indicates that when the concentration of Abrasive was adjusted to a low (1.00%) and the concentration of KNO₃ was adjusted to a high (4.00%), then the observed RR1 was high. Such Experiment was observed to result in a relatively high Selectivity, expressed as a high ratio: of the removal rate, RR1, of the barrier film, to a low removal rate, RR2, of the Dielectric layer. The high RR1 coincided with a high Selectivity, RR1/RR2, which identified a polishing fluid most suited for removal of the barrier film at a high removal rate, accompanied by a relatively low removal rate for removal of the Dielectric layer of silica. Table 1 indicates that highest Selectivity, RR1/RR2, corresponds with the KNO₃ in sufficient concentration to accelerate, i.e. increase, the removal rate, RR1, of the barrier film to a maximum, when accompanied by a weight percent of Abrasive that would remove the barrier film at an acceptable low removal rate, RR1, in the absence of the KNO₃.

Column 8 of Table 1 records an observed removal rate, RR3, that corresponds to a rate of removal of copper, Cu, from a wafer by polishing a wafer having copper thereon. Column 9 of Table 1 records Selectivity, RR1/RR3. The high values of Selectivity were observed in Experiments SPG-115 and SPG-117, in which the concentration of KNO₃ was adjusted to a high (4.00%). Such Experiments were observed to result in a high Selectivity for removal of the barrier film relative to copper, expressed as, a high ratio: of the removal rate, RR1, of the barrier film, to a low removal rate, RR3, of the Cu metal in the trenches. Accordingly, Experiments SPG-115 and SPG-117 resulted in relatively higher Selectivity, RR1/RR3, with respect to Cu. More specifically, the higher Selectivity, RR1/RR3=6.9 and RR1/RR3=4.8, are disclosed in Table 1, for Experiments SPG-115 and SPG-117, respectively. Further, Table 1 discloses, that such higher Selectivity, RR1/RR3, with respect to Cu, desirably coincided with higher Selectivity, RR1/RR2, with respect to the Dielectric layer. Thus, a conclusion can be drawn, that Experiment SPG-117, exhibits desirably high values of Selectivity, for removal of the barrier film relative to removal of both the Dielectric layer and Cu that corresponds to copper metal in trenches. Further, the Selectivity for high removal of the barrier film relative to a low removal of the Dielectric layer is maximized.

The experiments indicate that, adapting a polishing fluid, for removal of a barrier film of TaN, with KNO₃ in a solution of pH=9 enables removal of the barrier film with minimized abrasives, or, at least, substantially low levels of abrasives, and with maximized selectivity for removal of a barrier film relative to a dielectric layer. Further, the experiments indicate relatively high selectivity for removal of a barrier film relative to metal in trenches.

According to U.S. Pat. No. 6,001,730, polishing with a second step, CMP slurry of 10 pH consisting of, 7.5% abrasive, and an amine compound and water. The sole abrasive content in a disclosed experiment is 7.5%. The sole chemical reagent of the slurry is disclosed as an amine compound. No experiment is disclosed for recording selectivity obtained by polishing with a polishing fluid other than an amine compound.

According to Table 1, as disclosed herein, high Selectivity is obtained with an abrasives content below 7.5%. Experiment SPG-114 indicates that a high Abrasives presence, such as, 10.00% in the polishing fluid, removes a barrier film of TaN by abrasion, with a desirably high removal rate, RR1, of 1270 Angstroms per minute. TaN chemically reacts slowly with the chemistry of the polishing fluid. Consequently, removal of the barrier film of TaN by chemical reaction is slow. Thus, high abrasion has been required to attain a removal rate, RR1, of 1270 Angstroms per minute. However, polishing with a high abrasives content tends to increase the removal rates, RR2 and RR3, which contributes to erosion and dishing, respectively.

A comparison of Experiment SPG-116 with Experiment SPG-117, indicates that the invention provides high Selectivity, RR1/RR2 and RR1/RR3, for Experiment SPG-117, despite having increased the removal rates, RR2 and RR3 from lower levels that are recorded for Experiment SPG-116. Accordingly, the invention provides increased Selectivity, pertaining to removal of a barrier film relative to one, or the other of, or both of, the Dielectric layer and the copper metal in trenches, despite providing a low abrasives content in the polishing fluid, and despite causing an increase in one, or the other of, or both of, the removal rates RR2 and RR3.

When the Abrasives presence is lowered, Experiment SPG-116 indicates that the removal rate RR1 lowers to 35 Angstroms per minute. As further described herein, Table 1, Experiment SPG-117 records high Selectivity, obtained according to the invention.

Further, Table 1 discloses Selectivity obtained by polishing with a polishing fluid, and further discloses Selectivity obtained by polishing with the polishing fluid being adapted with KNO₃ in a solution of pH=9.

According to U.S. Pat. No. 6,001,730, polishing with a second step, CMP slurry consisting of, 7.5% abrasive, an amine compound, and water, obtains a selectivity of 550:340, or 1.62, pertaining to removal of a barrier film relative to a dielectric, and a selectivity of 550:330, or 1.67, pertaining to removal of a barrier film relative to copper metal. The polish rate of copper, 330 Angstroms per minute, is disclosed as being a sufficiently low copper removal rate.

According to Table 1, as disclosed herein, Experiments SPG-116 and SPG117 disclose that Selectivity pertaining to removal of a barrier film relative to a dielectric, i.e., silica, is maximized, as such Selectivity, RR1/RR2, increased from 35 to 1301. The same Experiments indicate that the removal rate RR2 pertaining to removal of the Dielectric layer increased from 23 to 69 Angstroms per minute, instead of decreasing. Accordingly, high Selectivity was not obtained by lowering the removal rate of the Dielectric layer. Further, the same Experiments disclose that Selectivity pertaining to removal of a barrier film relative to copper, i.e., metal in trenches, increased, as Selectivity, RR1/RR3, increased from 0.16 to 4.8. The same Experiments indicate that the removal rate RR3 pertaining to removal of the copper metal in trenches increased from 221 to 270, instead of decreasing. Accordingly, high Selectivity was not obtained by lowering the removal rate of the copper metal. Table 1 indicates that the invention increases Selectivity despite the absence of a low removal rate pertaining to removal of either, the Dielectric layer, or the metal in trenches, or both, the Dielectric layer and the metal in trenches.

According to WO 0028586, KNO₃ in a solution of acidic pH reacts with copper metal to form oxidizes of copper metal that are removed by first step polishing. However, second step polishing for removing the barrier film must minimize removal of copper in trenches to minimize dishing. Further, second step polishing must provide a high selectivity for removal of a barrier film relative to metal in trenches. Accordingly, a polishing fluid for second step polishing must be without an oxidizing reagent of copper metal.

The experiments described herein indicate that, KNO₃ in a solution of pH above the pH at which KNO₃ is an oxidizing reagent, provides anions that avoid oxidation of copper metal in trenches, which minimized dishing and provides high selectivity for removal of a barrier film relative to the metal in trenches. For example, according to Table 1, the pH is 9, for each of the experiments recorded in Table 1.

A suitable second step, polishing fluid is one that is without an oxidizing reagent of metal in trenches, as well as, without an oxidizing reagent of a barrier film. For example, the barrier film of TaN is a passivating metal. A passivating metal is a metal that chemically reacts with an oxidizing reagent constituent of the polishing fluid, or that chemically reacts with ambient oxygen dissolved in the polishing fluid, to form an oxide with an inhibition for chemical reaction with the polishing fluid. Such an oxide is a passivation oxide, the formation of which on the passivating metal would undesirably slow the chemical reaction and dissolution of the passivating metal during a polishing operation. As a result, the formation of the passivation oxide slows the rate of removal of the passivating metal by polishing.

Despite the absence of an oxidizing reagent in a second step, polishing fluid, ambient oxygen that has dissolved in the polishing fluid chemically reacts with the passivating metal to form a passivation oxide with an inhibition for chemical reaction with the polishing fluid. Consequently, formation of a passivation oxide on the passivating metal screens the passivating metal from a desired chemical reaction with the polishing fluid, which inhibits removal of the passivating metal by a polishing operation.

At the surface of the barrier film, for example, TaN, or alternatively, elemental Ta, the polishing fluid is intended to react chemically with the metal of the barrier film and dissolve the products of chemical reaction that are removed from the remainder of the barrier film by polishing. However, the metal is a passivating metal, one that readily corrodes, by reacting chemically with ambient oxygen that has become dissolved in the polishing fluid to form Ta₂O₅ that is screened by [TaO₂⁻] as a passivation oxide. The formation of a passivation oxide on the passivating metal inhibits chemical reaction of TaN or Ta with the polishing fluid, which inhibits removal of TaN or Ta by polishing. Accordingly, TaN, or alternatively, Ta, is but one of many embodiments of a passivating metal, a metal capable of chemical reaction to form a passivation oxide that inhibits removal of the metal by chemical reaction with the polishing fluid and dissolution. According to an embodiment of the invention, the presence of an anion species in the polishing fluid destabilizes passivation oxide screening by [TaO₂⁻] on TaN or Ta, which raises the removal rate of TaN or Ta by polishing with a polishing pad and the polishing fluid.

The polishing fluid of Experiment SPG-114 is adapted with the KNO₃ constituent that is but one of many species of a Lewis base, provided by a water soluble nitrate salt, any one of which is present in the polishing fluid in the form of a hard base anion species capable of adsorption with a passivating metal to inhibit corrosion, i.e., formation of a passivation oxide that would inhibit removal of the metal by a CMP polishing operation. The hard base anion species of a Lewis base is present in a concentration sufficient to accelerate, i.e., maximize, the removal rate of the passivating metal by polishing. As disclosed by Table 1, the Lewis base, as provided by the embodiment of KNO₃, would be an oxidizing reagent except for the pH of the polishing fluid being above the pH at which KNO₃ is an oxidizing reagent of metals. The Lewis base, for example, KNO₃, provides a hard base anion species for adsorption by forming stable bonds with the passivating metal, for example, TaN, a hard Lewis acid. Adsorption as a Lewis base, inhibits corrosion, i.e., formation of a passivation oxide on the passivating metal that would have inhibited chemical reaction of the passivating metal with the polishing fluid. It is believed that adsorption of the hard base ion species destabilizes the formation of absorption bonds of a passivation oxide with the passivating metal. In a pH above the pH at which KNO₃ in solution is an oxidizing reagent, adsorption of the hard base anion species KNO₃ inhibits corrosion of TaN. A technical analysis of anion adsorption is reviewed in a technical paper; Aramaki, Kunitsugu; “Adsorption Behavior of Ions Related to Corrosion Phenomena and the Hard and Soft Acid and Base Principle”, Corrosion Engineering, Volume 46, Pages 389-405 (1997), Allerton Press, Inc. 18 West 27^{th} Street, New York, N.Y., USA.

The copper, i.e., metal in trenches, forms an oxide film by reaction with atmospheric oxygen, until covered by the polishing fluid. The BTA in the polishing fluid inhibits a reaction of copper with oxygen dissolved in the polishing fluid to form an oxide. Polishing would remove oxidized copper more quickly than unoxidized copper. The KNO₃ in a solution is a known oxidizing reagent of copper. In a pH above the pH at which KNO₃ in solution is an oxidizing reagent, the KNO₃ is inhibited from being an oxidizing reagent of copper metal in trenches, which would have increased the removal rate RR3 of the copper to unacceptable high values. Further, the KNO₃ is a hard base ion species of a Lewis base, which comprises a hard Lewis base. Copper is a soft Lewis acid. Accordingly, KNO₃ as hard Lewis base is inhibited from adsorption on copper as a soft Lewis acid. Inhibiting adsorption of KNO₃ on copper will minimize an increase in the copper removal rate by second step polishing.

A polishing fluid having an ordinary, soluble salt maximizes selectivity for removal of a barrier film relative to an underlying dielectric layer on a semiconductor wafer when polishing the barrier film with a polishing pad and the polishing fluid.

A known reagent, when present in a polishing fluid of a pH above the pH at which the reagent in solution is an oxidizing reagent, provides a hard base anion species of a Lewis base that inhibits formation of a passivation oxide on a barrier film, enabling a polishing operation to remove the barrier film from a dielectric layer by polishing, while avoiding oxidation of metal in trenches in the dielectric layer.

What is claimed is:

1. A polishing fluid for removal of a barrier film from a dielectric layer on a semiconductor wafer by polishing with a polishing pad and the polishing fluid, comprising: the polishing fluid having a concentration of an adsorbing anion for adsorption on the barrier film, the pH of the polishing fluid being above the pH at which the adsorbing anion is an oxidizing reagent of metal, and the anion deterring formation of a passivation oxide on the barrier film, which maximizes removal of the barrier film relative to the dielectric layer by polishing.

2. The polishing fluid as recited in claim 1 wherein, the anion is a nitrate anion.

3. The polishing fluid as recited in claim 1 wherein, the polishing fluid is an aqueous solution of about 9 pH.

4. The polishing fluid as recited in claim 1 wherein, submicron particles are present in a sufficiently low weight percent that would remove the barrier film at an acceptable low removal rate in the absence of the hard base anion.

5. The polishing fluid as recited in claim 4, and further comprising:
submicron particles being less than 7.5% by weight in the polishing fluid.

6. The polishing fluid as recited in claim 5, and further comprising: the anion comprising, a Lewis base in the form of a hard base anion for adsorption on the barrier film, and inhibited from oxidizing metal in trenches in the dielectric layer, to provide relatively high selectivity for removal of the barrier film relative to the metal in trenches.

7. The polishing fluid as recited in claim 6, and further comprising: the hard base anion inhibited from adsorption an metal in trenches in a dielectric layer on a semiconductor wafer, with high selectivity for removal of the passivating metal relative to the metal in trenches.

8. The polishing fluid as recited in claim 1, and further comprising:
submicron particles being less than 7.5% by weight in the polishing fluid.

9. The polishing fluid as recited in claim 8 wherein, the anion is a nitrate anion.

10. The polishing fluid as recited in claim 8 wherein, the polishing fluid is an aqueous solution of about 9 pH.

11. The polishing fluid as recited in claim 8, and further comprising: the anion comprising, a Lewis base in the form of a hard base anion for adsorption on the barrier film, and inhibited from oxidizing metal in trenches in the dielectric layer, to provide relatively high selectivity for removal of the barrier film relative to the metal in trenches.

12. The polishing fluid as recited in claim 8, and further comprising: the hard base anion inhibited from adsorption on metal in trenches in a dielectric layer on a semiconductor wafer, with high selectivity for removal of the passivating metal relative to the metal in trenches.

13. The polishing fluid as recited in claim 1, and further comprising: the anion comprising, a Lewis base in the form of a hard base anion for adsorption on the barrier film, and inhibited from oxidizing metal in trenches in the dielectric layer, to provide relatively high selectivity for removal of the barrier film relative to the metal in trenches.

14. The polishing fluid as recited in claim 13 wherein, the anion is a nitrate anion.

15. The polishing fluid as recited in claim 13 wherein, the polishing fluid is an aqueous solution of about 9 pH.

16. The polishing fluid as recited in claim 13, and further comprising: the hard base anion being inhibited from adsorption on metal in trenches in a dielectric layer on a semiconductor wafer, with high selectivity for removal of the passivating metal relative to the metal in trenches.

17. The polishing fluid as recited in claim 16 wherein, submicron particles are present in a sufficiently low weight percent that would remove the barrier film at an acceptable low removal rate in the absence of the hard base anion.

18. The polishing fluid as recited in claim 1, and further comprising: the hard base anion being inhibited from adsorption on metal in trenches in a dielectric layer on a semiconductor wafer, with high selectivity for removal of the passivating metal relative to the metal in trenches.

19. The polishing fluid as recited in claim 18 wherein, the anion is a nitrate anion.

20. The polishing fluid as recited in claim 18 wherein, the polishing fluid is an aqueous solution of about 9 pH.

21. The polishing fluid as recited in claim 18 wherein, submicron particles are present in a sufficiently low weight percent that would remove the barrier film at an acceptable low removal rate in the absence of the hard base anion.

22. The polishing fluid as recited in claim 1 wherein, submicron particles are present in a sufficiently low weight percent that would remove the barrier film at an acceptable low removal rate in the absence of the hard base anion, submicron particles being less than 7.5% by weight in the polishing fluid, and the hard base anion being inhibited from adsorption on metal in trenches in a dielectric layer on a semiconductor wafer, with high selectivity for removal of the passivating metal relative to the metal in trenches.

23. The polishing fluid as recited in claim 1, and further comprising: the anion comprising, a Lewis base in the form of a hard base anion for adsorption on the barrier film, and being inhibited from oxidizing metal in trenches in the dielectric layer, to provide relatively high selectivity for removal of the barrier film relative to the metal in trenches, and the hard base anion being inhibited from adsorption on metal in trenches in a dielectric layer on a semiconductor wafer, with high selectivity for removal of the passivating metal relative to the metal in trenches.

24. In a polishing fluid for polishing a passivating metal comprising: a nonoxidizing reagent for removal of the passivating metal by polishing, submicron particles, and water, the improvement comprising: the reagent being a hard base anion as a species of a Lewis base for adsorption on the passivating metal, and the hard base anion being present in a concentration that maximizes removal of the passivating metal in the absence of the passivation oxide.

25. In the polishing fluid as recited in claim 24, and further wherein, the anion is a nitrate anion.

26. In the polishing fluid as recited in claim 24, and further wherein, the polishing fluid is of about 9 pH.

27. In the polishing fluid as recited in claim 24, and further wherein, the polishing fluid is an aqueous solution of pH above the pH at which the hard base anion is an oxidizing reagent of metal.

28. In the polishing fluid as recited in claim 27, and further wherein, the anion is a nitrate anion.

29. In the polishing fluid as recited in claim 27, and further wherein, the polishing fluid is of about 9 pH.

30. In the polishing fluid as recited in claim 27, and further wherein, the submicron particles are present in a sufficiently low weight percent that would remove the barrier film at an acceptable low removal rate in the absence of the hard base anion.

31. In the polishing fluid as recited in claim 30, the improvement further comprising: the hard base anion being inhibited from adsorption on metal in trenches in a dielectric layer on a semiconductor wafer, with high selectivity for removal of the passivating metal relative to the metal in trenches.

32. In the polishing fluid as recited in claim 31, and further wherein, the submicron particles are less than 7.5% by weight in the polishing fluid.

33. In the polishing fluid as recited in claim 24, and further wherein, the submicron particles are present in a sufficiently low weight percent that would remove the barrier film at an acceptable low removal rate in the absence of the hard base anion.

34. In the polishing fluid as recited in claim 33, the improvement further comprising: the hard base anion being inhibited from adsorption on metal in trenches in a dielectric layer on a semiconductor wafer, with high selectivity for removal of the passivating metal relative to the metal in trenches.

35. In the polishing fluid as recited in claim 33, and further wherein, the submicron particles are less than 7.5% by weight in the polishing fluid.

36. In the polishing fluid as recited in claim 33, and further wherein, the anion is a nitrate anion.

37. In the polishing fluid as recited in claim 33, and further wherein, the polishing fluid is of about 9 pH.

38. In the polishing fluid as recited in claim 24, the improvement further comprising: the hard base anion being inhibited from adsorption on metal in trenches in a dielectric layer on a semiconductor wafer, with high selectivity for removal of the passivating metal relative to the metal in trenches.

39. In the polishing fluid as recited in claim 38, and further wherein, the submicron particles are less than 7.5% by weight in the polishing fluid.

40. In the polishing fluid as recited in claim 38, and further wherein, the anion is a nitrate anion.

41. In the polishing fluid as recited in claim 38, and further wherein, the polishing fluid is of about 9 pH.

42. In the polishing fluid as recited in claim 24, and further wherein, the submicron particles are less than 7.5% by weight in the polishing fluid.

43. In the polishing fluid as recited in claim 42, and further wherein, the anion is a nitrate anion.

44. In the polishing fluid as recited in claim 42, and further wherein, the polishing fluid is of about 9 pH.

45. In the polishing fluid as recited in claim 24, and further wherein, the polishing fluid is an aqueous solution of pH above the pH at which the hard base anion is an oxidizing reagent of metal, the submicron particles are present in a sufficiently low weight percent that would remove the barrier film at an acceptable low removal rate in the absence of the hard base anion, and the submicron particles are less than 7.5% by weight in the polishing fluid.

46. In the polishing fluid as recited in claim 24, the improvement further comprising: the hard base anion being inhibited from adsorption on metal in trenches in a dielectric layer on a semiconductor wafer, with high selectivity for removal of the passivating metal relative to the metal in trenches ,and the submicron particles are less than 7.5% by weight in the polishing fluid.

48. In a polishing fluid as recited in claim 24, the improvement further comprising: the reagent being a hard base anion as a species of a Lewis base for adsorption on the passivating metal and deterring formation of a passivation oxide on the passivating metal.
